(19) United States
(12) Patent Application Publication
(10) Pub. No.: US 2002/0085813 A1
(43) Pub. Date: Jul. 4, 2002

(54) Coupling structure of arm portable information apparatus

(76) Inventor: Gen Mitamura, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 09/915,445

(22) Filed: Jul. 26, 2001

(30) Foreign Application Priority Data
Jul. 31, 2000 (JP) 2000-231977

(51) Int. Cl. G02B 6/36

(52) U.S. Cl. 385/53

(57) ABSTRACT

To provide a coupling structure capable of rotating and waterproofing a communication cable while communicating it. In a fitting portion, a communication hole having a proper diameter is provided to a portion ranging from the periphery of the center of a connector attaching hole to the center of a rotational axis of an engagement surface between the fitting portion and a fitting portion. A communication hole is provided in the fitting portion in the same manner. Finally, the connector attaching hole on the main body side and a connector attaching hole on the function unit side are in communication through the two communication holes passing through the center of the rotational axis. Therein, the communication cable communicates. A sealing member having a ring shape such as an O-shaped ring is provided at the opening of the communication hole of the hinge-piece fitting portion on the main body side. As diameters of the sealing member, the outer diameter that is slightly larger than the inner diameter of the communication hole and the inner diameter that is slightly smaller than the outer diameter of the communication cable are adopted.

### BACKGROUND OF THE INVENTION

1. Field of the Invention

The present invention relates to a hinge, and more particularly, to a hinge of an arm-type information apparatus having a coupling function, a waterproof function, and connection functions of an electric interconnection, an optical cable, and other communication cables.

2. Description of the Prior Art

Recently, attention is paid to excellent portability of an arm-type portable, and an arm portable information apparatus for information processing as a main function comes onto the market. Many kinds of arm portable information apparatuses having various functions and combination of functions are prepared in accordance with user's various necessities.

However, in the arm portable information apparatuses, an area of an electric circuit for information processing and an adding function and an area of an operation unit or a display unit must be increased in accordance with a high function and a multi-function for information processing. Thus, a structure is considered such that a single unit is set for each function and units are coupled to the main body.

However, in the case of coupling units, etc. which require a GPS (global positioning system) function and other communication to the main body of the arm portable information apparatus, if the units, etc. are always fixedly coupled in the same direction, there is a problem in that the coupling is improper for the communication and the human body must have poor posture, thereby not exhibiting the corresponding function. If the coupling structure can be moved by any method, specific coupling such as an FPC (flexible print circuit) is necessary when wire communication has to be performed between the arm portable information apparatus and each unit. There is problem in that not only costs increase but also coupling separate from the coupling structure is remarkably troublesome. Further, since the arm portable information apparatus is literally portable to the arm, preferably, a waterproof function may preferably be provided.

### SUMMARY OF THE INVENTION

The present invention is made in consideration of the above, and an object of the present invention is to provide a coupling structure capable of rotating the main body of an arm portable information apparatus and a function unit and also communicating a communication cable for wire communication, etc. through the center of the apparatus, and capable of a waterproof function.

In order to solve the object, according to a coupling structure of an arm portable information apparatus of the present invention, in the coupling structure of the arm portable information apparatus for coupling a plurality of units constituting the arm portable information apparatus, a hinge is used as the coupling structure, and a communication hole for communicating a side end surface of one unit and a side end surface of the other end surface through a rotational axis of the hinge is formed.

In the arm portable information apparatus, units having various functions, so-called function units can be coupled separately from the main body, and the function units are considered to be coupled each other. This coupling may necessitate means for interchanging information between the units including interchanging the information between the main body and the unit. In other words, generally, the function unit may need to be connected to the main body through a communication cable (including an optical cable). For the purpose of assuring functions of the arm portable information apparatus and the function unit and of matching to an arm form of the human, the coupling method preferably has both of a coupling function and a rotating function. Thus, a hinge is used to a coupling portion. By forming the communication hole which communicates the side end surface of the one unit and the side end surface of the other unit through the rotational axis of the hinge, a communication cable, etc. can communicate through the communication hole while holding the rotating function of the hinge. Also, by forming the communication hole through the rotational axis of the hinge, no shear force acts on the communication cable passing through the hole.

According to a coupling structure of an arm portable information apparatus of the present invention, in the coupling structure of the arm portable information apparatus for coupling a plurality of units constituting the arm portable information apparatus, a hinge is used as the coupling means, a part of the axial core of the hinge is omitted, and a communication hole for communicating a side end surface of one unit and a side end surface of the other unit through the omitted part of the rotational axis is formed.

In the present invention, because a part of the axial core of the hinge is omitted, the communication hole which communicates the side end surface of the one unit and the side end surface of the other unit through the omitted part of the axial core can be provided and the axial core is not an obstacle to piercing. If providing the communication hole, it is possible to hold the inherent coupling function and rotating function of the hinge.

According to the coupling structure of the arm portable information apparatus of the present invention, the axial core is provided to both ends of the rotational axis, and the axial core at the center is omitted in the coupling structure.

A hinge piece has fitting portions. If engaging a part of the fitting portions, it is possible to ensure the coupling function and the rotating function of the hinge. According to the present invention, because the axial core is inserted to both the ends of the rotational axis, both the functions are ensured. By providing the axial core to both the ends of the rotational axis of the hinge, the hinge piece suppresses vibration due to external force as compared with the case of providing the axial core only at the center. That is, since the length of the hinge piece in the rotational axis direction is increased, the vibration of the hinge piece can be suppressed. Further, when resolving the hinge portion, the axial core can be externally detached. Also, because the axial core at the center of the hinge of the present invention is omitted, the communication hole which communicates through each unit side can be provided to the omitted part without damaging the coupling function and rotating function by the axial core of both the ends.

According to the coupling structure of the arm portable information apparatus of the present invention, a screw, a hook projection, and another drawing-out structure are provided to an end portion of the axial core in the coupling structure.

In the coupling structure of the present invention, the axial core is provided to both ends of the rotational axis, and thus, one end of the axial core is necessarily exposed to the outside of the coupling structure. Therefore, when the axial core has a screw portion, the screw is rotated forward/backward, thereby enabling the insertion and drawing-out. When the axial core does not have a screw portion, the insertion and drawing-out becomes possible if a portion, to which the axial core is exposed, has the hook projection and the other drawing-out structure.

According to a coupling structure of an arm portable information apparatus of the present invention, in the coupling structure of the arm portable information apparatus for coupling a plurality of units constituting the arm portable information apparatus, a hinge is used as the coupling means, a non-through hole is provided in a rotational axis direction from an engagement surface formed by jointing right and left hinge-pieces, and a through-hole which communicates from the non-through hole to an external side end surface is provided, thereby forming a communication hole which communicates a side end surface of one unit and a side end surface of the other unit.

Thus, a vacant hole communicates through between the units including between the main body and the unit. The communication cable, etc. can communicate through the vacant hole without squashing the vacant hole, when the hinge rotates. The communication cable is interconnected through the hinge and, therefore, the interconnection is not seen from the outside and the external appearance is improved. It is easy to provide the non-through hole to both sides in the rotational axis direction from the engagement surface formed by jointing right and left hinge-pieces and also to provide the through-hole which passes through the external end surface from the non-through hole.

According to the coupling structure of the arm portable information apparatus of the present invention, in any one of the above-described coupling structures, further, a communication cable communicates through the communication hole.

In the present invention, the communication cable passes through the communication hole. Thus, communication between the main body and the function unit or between the function units is possible without squashing the vacant hole, when the hinge rotates. The communication cable is exposed only to the engagement surface and the side end surfaces of two units outside the hinge, and therefore, a waterproof process is easily performed with high sealability.

According to the coupling structure of the arm portable information apparatus of the present invention, in any one of the coupling structures described above, waterproof means is provided to a coupling portion of the hinge.

In the present invention, the waterproof means is provided to the coupling portion of the hinge. Thus, the communication cable passing through the communication hole does not get wet with water.

According to the coupling structure of the arm portable information apparatus of the present invention, further, ring-shaped waterproof means is provided to the opening of the non-through hole, an interference is provided to an outer diameter of the waterproof means and to an inner diameter of the non-through hole, and an interference is provided to an inner diameter of the waterproof means and to an outer shape of the communication cable, thereby preventing inflow into the non-through hole.

The waterproof means is provided to the opening of the non-through hole. Thus, a gap between the non-through hole and the communication cable is absent and the inflow from the opening to the non-through hole can be prevented.

According to the coupling structure of the arm portable information apparatus of the present invention, ring-shaped waterproof means is further provided to the opening of the non-through hole and an interference is provided in a rotational axis direction, thereby preventing inflow into the non-through hole.

The ring-shaped waterproof means is provided to the engagement surface of both hinge pieces as the opening of the non-through hole without space. Thus, no water from the outside can inflow into the non-through hole.

According to the coupling structure of the arm portable information apparatus of the present invention, further, a connector for connecting the unit is provided to an exit of the communication hole.

The hinge as the coupling structure of the present invention is to couple the main body of the arm portable information apparatus and the function unit or to couple the function units. The function unit is attached/detached to the main body or other function unit in accordance with the function. Therefore, in the case of coupling a casing, the communication cable needs to be connected. In the hinge as the coupling structure of the present invention, the connector for connecting the unit is provided to the exit of the communication hole. Therefore, the main body or the function unit can be connected to the other unit and at the same time, the energization is possible by the connector.

According the coupling structure of the arm portable information apparatus of the present invention, further, hinge pieces constituting the hinge have the same shape.

In the hinge of the present invention, the hinge pieces constituting the hinge have the same shape. Thus, the hinge pieces having a single shape may be designed and produced. If there is a pair of hinge pieces, and one hinge piece is opposed to the other hinge piece with point symmetry of 180°, both pieces are necessarily fit. The joint becomes easier than that of a hinge comprising hinge pieces having different shapes.

### BRIEF DESCRIPTION OF THE SEVERAL VIEWS OF THE DRAWINGS

A preferred form of the present invention is illustrated in the accompanying drawings in which:

FIG. 1 is a perspective view showing a coupling structure of an arm portable information apparatus according to a first embodiment of the present invention when the coupling structure is used for coupling of the arm portable information apparatus and a function unit;

FIG. 2 is a front view and a side view showing the constitution of a hinge according to the first embodiment of the present invention;

FIG. 3 is a cross-sectional view showing the center of the hinge when a communication cable communicates through a communication hole from a connector;

FIG. 4 are an external view and a cross-sectional view showing an axial-core shape, and a screw-in state and an insertion state;

FIG. 5 is a front view showing the hinge in which the communication hole shown in FIG. 2 is linearly pierced; and

FIG. 6 are enlarged views showing the periphery of engagement surfaces of hinges according to a second embodiment of the present invention.

### DETAILED DESCRIPTION

A detailed description is given of coupling structures of arm portable information apparatuses according to embodiments of the present invention with reference to the accompanying drawings. Incidentally, the present invention is not limited to the embodiments.

First Embodiment

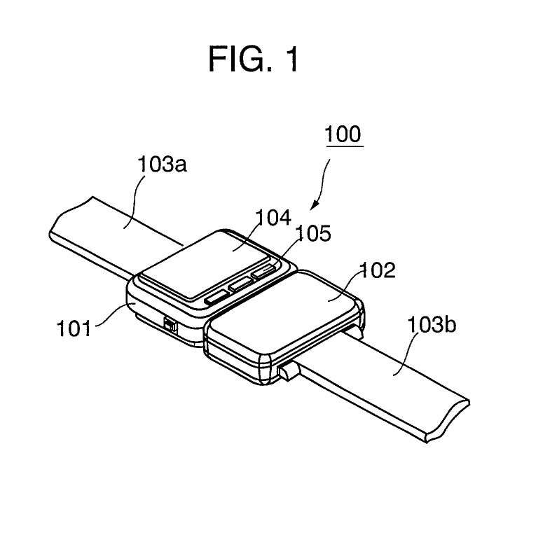

FIG. 1 is a perspective view of a coupling structure of an arm portable information apparatus according to a first embodiment of the present invention when the arm portable information apparatus is coupled to a function unit. An arm portable information apparatus 100 comprises: a main body 101 having an electric circuit (not shown) for information processing; a function unit 102 having an electric circuit (not shown) for an adding function; a hinge 201 for coupling the function unit 102 to the main body 101 communicably and movably around the arm; and bands 103a and 103b for fixing the arm portable information apparatus 100 to the arm.

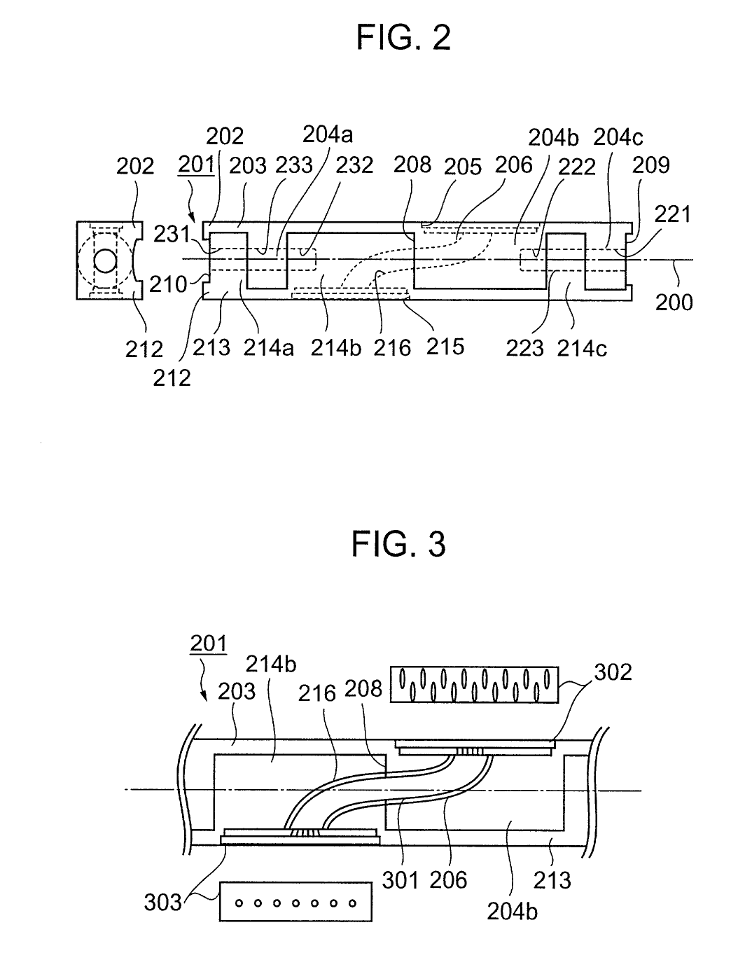

FIG. 2 is a front view and a side view showing the structure of the hinge 201 according to the first embodiment. The hinge 201 according to the first embodiment comprises a hinge piece 202 on the main body side and a hinge piece 212 on the function unit side which is arranged with point symmetry of 180° to the hinge piece 202. Further, the hinge piece 202 on the main body side comprises: a hinge-piece base portion 203 on the main body side; and three fitting portions 204a, 204b, and 204c. Also, the hinge piece 212 on the function unit side comprises: a hinge-piece base portion 213 on the function unit side; and three fitting portions 214a, 214b, and 214c. Although a description is given of the hinge having three fitting portions in the figure, the number of fitting portions is not limited and is a proper number in accordance with the dimension of the arm-type information apparatus.

As a fundamental constitution of the fitting portion 204b, a connector attaching hole 205 is pierced to a side end surface on the main body of the hinge-piece base portion 203 on the main body side, and a connector attaching hole 215 is pierced to a side end surface on the function unit of the hinge-piece base portion 213 on the function unit side with point symmetry thereto. In the fitting portion 204b, a communication hole 206 having a proper diameter is provided from the periphery of the center of the connector attaching hole 205 to the center of a rotational axis 200 of an engagement surface 208 between the fitting portion 204b and the fitting portion 214b. Also, a communication hole 216 is provided in the fitting portion 214b. Finally, the connector attaching hole 205 on the main body side and the connector attaching hole 215 on the function unit side are in communication through two communication holes passing through the center of the rotational axis 200.

A through-hole 221 for insertion of the axial core is pierced to an end surface 209 vertical to the rotational axis 200 of the hinge piece 202 on the main body side. A non-through hole 222 is pierced to the fitting portion 204b. A through-hole 223 having the same diameter as the through-hole 221 is pierced to the fitting portion 214c on the function unit side which is fit between the fitting portions 204b and 204c on the main body side. Thus, the axial core can be inserted into the two through-holes 221 and 223 and the non-through hole 222 from the end surface 209.

A through-hole and a non-through hole 232 are pierced to the fitting portion 214a on the function unit side and the fitting portion 214b, respectively, to insert the axial core to an end surface 210 on the opposite side of the end surface 209. Also, a through-hole 233 is pierced to the fitting portion 204a on the main body side. As mentioned above, in the coupling structure according to the first embodiment, the hinge is used and the axial core at the center of the hinge is omitted.

Operation in the above structure will be described hereinbelow. By forming the communication holes 206 and 216 for communicating with the engagement surface 208 through the rotational axis 200 of the hinge 201, a communication cable, etc. can communicate with the communication holes 206 and 216 while holding a rotating function of the hinge 201. The communication holes 206 and 216 are formed to pass through the rotational axis 200 of the hinge 201 and thus, no shear force is applied to the engagement surface 208 in the communication cable passing through the communication holes 206 and 216. The damage of the communication cable due thereto can be prevented.

Since a part of the axial core of the hinge 201 is omitted, the communication holes 206 and 216 are provided through the omitted part of the axial core, and the axial core becomes no obstacle for piercing the communication holes 206 and 216. With the above-described structure, if the communication holes are provided, it is possible to hold inherent coupling function and rotating function of the hinge 201. The axial core is provided at both ends of the rotational axis 200 of the hinge 201, and thus, twist due to external force of the hinge piece can be suppressed as compared with the case in which the axial core is provided only at the center.

FIG. 3 is a cross-sectional view showing the hinge center portions 204b and 214b when the communication cable passes through the communication holes 206 and 216 from the connector. In the hinge 201 according to the first embodiment, by communicating a communication cable 301 through the communication holes 206 and 216, communication between the arm-type information apparatus main body and the function unit or between the function units is possible without squashing the communication holes 206 and 216 when the hinge 201 rotates.

It is easy to perform a waterproof process with high sealability, without exposing the communication cable 301 outside the hinge 201. Incidentally, connectors 302 and 303 are set to ends of the hinge-piece base portion 203 on the main body side and the hinge-piece base portion 213 on the function unit side and shapes of the connectors are different in the figure. However, a proper shape is selected by a communication method of two units which are coupled by the hinge and, fundamentally, the shape is not limited.

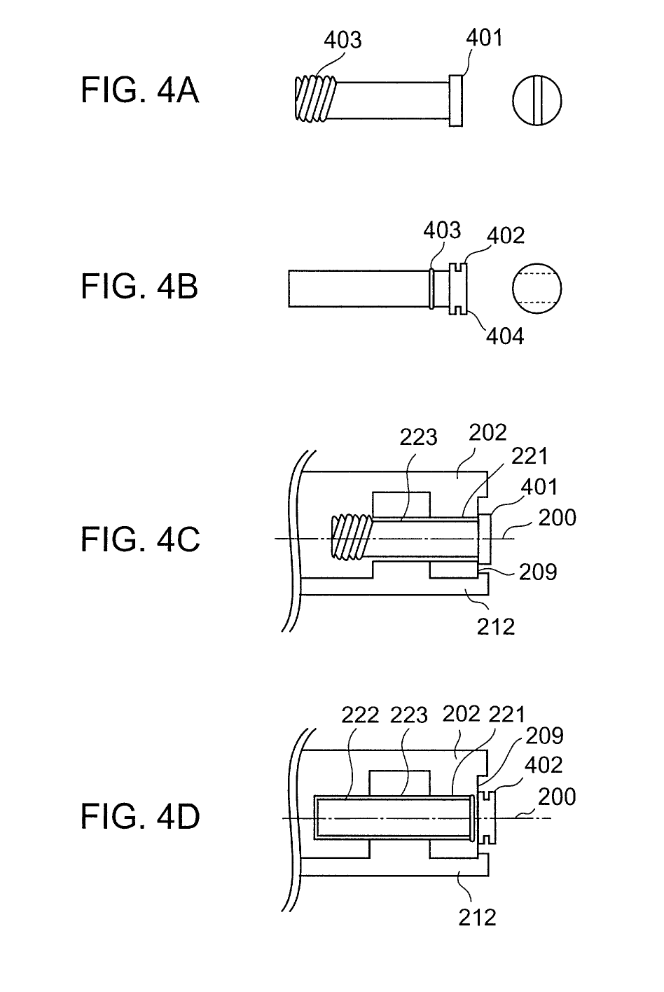

FIG. 4 show axial-core shapes and screw-in and insertion states of the axial core. The diagram A is an external view of an axial core 401 having a screw portion 403. FIG. 4C is a diagram when the axial core 401 is screwed in a female screw which is screwed and cut in the through-holes 221 and 223 of the hinge piece 202 on the main body side and of the hinge piece 212 on the function unit side and in the non-through hole 222 of the hinge piece 202 on the main body side. FIG. 4B is an external view of an axial core 402 having a minimum engagement portion 403 in the circumferential direction of the axial core and a hook groove at the head. Similarly to FIG. 4C, FIG. 4D is a diagram when the axial core 402 is inserted into the through-holes 221 and 223 of the hinge piece 202 on the main body side and of the hinge piece 212 on the function unit side and into the non-through hole 222 of the hinge piece 202 on the main body side.

As shown in FIGS. 4 A and 4C, in the hinge 200 according to the first embodiment, the axial core 401 or 402 is screwed or inserted from the end surface 209 vertical to the rotational axis, and thus, the head of the axial core 401 or 402 is necessarily exposed to the outside. Consequently, in the case of the axial core 401 having the screw portion shown in FIG. 4A, the screw is rotated forward/backward, thereby enabling the screw-in and screw-out. In the case of the axial core 402 having no screw portion shown in FIG. 4B, if a hook projection 404 is provided to the head at which the axial core 402 is exposed, the insertion and drawing-out are possible as shown in FIG. 4D. Although the engagement portion 403 is provided in the circumferential direction of the axial core in FIG. 4B, this is because it is prevented that the axial core 402 is arbitrarily dropped out and, any means may be used instead of the above engagement means if it prevents the arbitrary dropping-out.

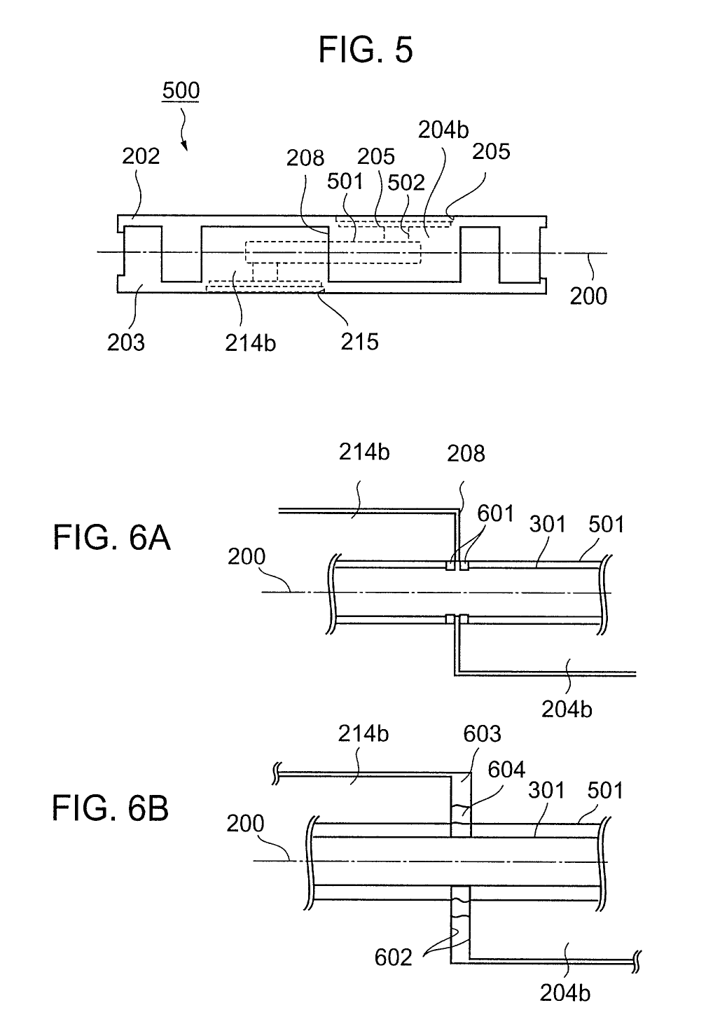

Although the above description is given of the hinge 201 having the hinge pieces in which the communication holes 206 and 216 shown in FIG. 2 have smooth curves, the communication holes may have no smooth curve. A description is given of a hinge having a communication hole which is linearly pieced hereinbelow. FIG. 5 is a front view of a hinge 500 in which the communication holes 206 and 216 of the hinge 201 shown in FIG. 2 are linearly pierced. The hinge piece 202 on the main body side and the hinge piece 203 on the function unit side have a symmetric shape, and therefore, only one hinge piece is described and a description of the other hinge piece is omitted.

As shown in the figure, in communication holes 501 and 502 of the hinge 500, first, the non-through hole 501 having a proper length is provided on the rotational axis 200 starting at the engagement surface 208, and subsequently, the through-hole 502 to communicate through the connector attaching hole 205 on the side end surface of the main body is provided starting at the non-through hole 501.

As mentioned above, if the communication holes 501 and 502 are linearly provided, the communication cable 301 can communicate, similarly to the hinge 201 comprising the hinge pieces provided with the smooth curve. If the hinge 500 is bent with the rotational axis 200 as center, the main body 101 of the arm portable information apparatus can communicate with the function unit 102. By linearly providing the communication holes as mentioned above, mechanical processing becomes simple and mass production is also possible without molding.

Second Embodiment.

A coupling structure of an arm-type information apparatus according to a second embodiment is such that a waterproof structure is added to the coupling structure of the arm-type information apparatus according to the first embodiment. FIG. 6 are enlarged views showing the periphery of the engagement surface of the hinge according to the second embodiment of the present invention.

First, a description is given of the constitution of FIG. 6A. In the figure, starting at the engagement surface 208 between the hinge-piece fitting portion 204b on the main body side and the hinge-piece fitting portion 214b on the function unit side, the non-through hole 501 is provided along the rotational axis 200, and the communication cable 301 communicates through the non-through hole 501. A sealing member 601 having a ring shape such as an O-shaped ring is fit to the opening of the non-through hole 501 of the hinge-piece fitting portion 204b on the main body side. As diameters of the sealing member 601, the outer diameter that is slightly larger than the inner diameter of the non-through hole 501 and the inner diameter that is slightly smaller than the outer diameter of the communication cable 301 are adopted.

Thus, the sealing member 601 has an interference for the non-through hole 501 and the communication cable 301, and thus, a gap between the non-through hole 501 and the communication cable 301 is completely stopped. Although the sealing member 601 has a rectangle-sectional shape as shown in the figure, the sectional shape is not limited thereto and may be circular or the like. In order to accurately fix the sealing member 601 to the opening of the non-through hole 501, a groove or a step is provided to the opening of the non-through hole 501 and the sealing member 601 may be fit thereto.

Subsequently, a description is given of the constitution in FIG. 6B. In the figure, similarly to the case in FIG. 6A in the above description, the non-through hole 501 is provided along the rotational axis 200 starting at an opposite surface 602 between the hinge-piece fitting portion 204b on the main body side and the hinge-piece fitting portion 214b on the function unit side, and the communication cable 301 communicates through the non-through hole 501. The different point from that of FIG. 6A is that a gap 603 is provided between the hinge-piece fitting portion 204b on the main body side and the hinge-piece fitting portion 214b on the function unit side and a ring-shaped sealing member 604 is inserted into the gap 603 with an interference in the rotational axis direction.

In any one of the structures in FIGS. 6A and 6B, the sealing members 601 and 604 are provided to the opening of the non-through hole 501, thereby stopping the gap between the non-through hole 501 and the communication cable 301. This results in enabling the prevention of inflow to the non-through hole 501 from the opening. Accordingly, electric leakage and communication miss can be prevented without making the communication cable 301 through the communication hole get wet with water.

As described above, in the coupling structure of the present invention, the hinge is used as a coupling method of the main body of the arm portable information apparatus and function unit, or of the function units. Thus, it is possible to ensure both the rotating function with the rotational axis of the hinge as center and the coupling function. By forming the communication hole which communicates with the side end surface of the one unit and the side end surface of the other unit through the rotational axis of the hinge, a communication cable, etc. can communicate through the communication hole while holding the rotating function of the hinge. Hence, the interchange of information, i.e., the energization becomes possible between the units with which the hinge communicates. Also, by forming the communication hole through the rotational axis of the hinge, if one hinge piece rotates for the other hinge piece, no shear force acts on the communication cable passing through the hole and the communication cable is not damaged.

In the coupling structure of the present invention, the hinge is used as a coupling method of the main body of the arm portable information apparatus and function unit, or of the function units. Thus, it is possible to ensure both the rotating function with the rotational axis of the hinge as center and the coupling function. Because a part of the axial core of the hinge is omitted, the communication hole which communicates through the side end surface of the one unit and the side end surface of the other unit can be provided through the omitted part of the axial core and the axial core is not an obstacle to piercing. If providing the communication holes, it is possible to hold the inherent coupling function and rotating function as the hinge. By forming the communication holes, the communication cable, etc. can communicate through the communication hole while holding the rotating function of the hinge. Hence, the interchange of information, i.e., the energization becomes possible between the units with which the hinge communicates. Also, by forming the communication holes through the rotational axis of the hinge, if one hinge piece rotates for the other hinge piece, no shear force acts on the communication cable passing through the hole and the communication cable is not damaged.

In the coupling structure of the present invention, the axial core is inserted to both ends of the rotational axis. Thus, it is possible to ensure both the rotating function and the coupling function of the hinge. By providing the axial core to both the ends of the rotational axis of the hinge, the axial core can be easily inserted and detached from both the ends. Also, by providing the axial core to both the ends of the rotational axis of the hinge, it is suppressed that the hinge pieces are drawn out in the rotational axis direction by external force, and twist of the function units coupled by the hinge can be prevented. The center of the axial core is omitted, and thus, the communication holes which communicate with each unit side can be provided at the omitted part without damaging the coupling function and the rotating function by the axial core at both ends.

In the coupling structure of the present invention, the axial core is provided at both ends of the rotational axis, thereby necessarily exposing one end of the axial core to the outside of the coupling structure. When the axial core has a screw portion, the screw is rotated forward/backward, thereby enabling the insertion and drawing-out. When the axial core has no screw portion, the insertion and drawing-out are possible if a portion at which the axial core is exposed has the hook projection and another drawing-out structure.

In the coupling structure of the present invention, the manufacture is easy by mechanical processing or molding. The communication cable, etc. can communicate the communication holes formed by the non-through hole provided in the rotational axis direction from the engagement surface obtained by jointing right and left hinge-pieces and by the through-hole provided so as to communicate with the external end surface from the non-through hole without squashing the communication holes when the hinge rotates. The communication cable is interconnected through the hinge, and therefore, the interconnection is not seen from the outside and the external appearance is improved. Further, when the communication cable communicates through the communication holes, since the communication cable is exposed only to the engagement surface and the side surfaces of two units outside the hinge, it is easy to perform a waterproof process with high sealability.

In the coupling structure of the present invention, the communication cable, etc. communicates through the communication holes. Thus, communication between the main body and the function unit or between the function units is possible without squashing the vacant hole when the hinge rotates. Since a general electric wire and an optical cable generally used for communication can communicate through the communication holes as they are, it is unnecessary to especially use an FPC (flexible print circuit) used for wiring in a narrow space. Therefore, costs are reduced. Since the communication cable is exposed only to the engagement surface and the side end surfaces of two units outside the hinge, it is easy to perform a waterproof process with high sealability. The communication cable is interconnected through the hinge, and therefore, advantageously, the interconnection is not seen from the outside and the external appearance is improved.

In the coupling structure of the present invention, the waterproof means is provided to the coupling portion of the hinge. Thus, electric leakage and communication miss can be prevented without making the communication cable through the communication hole get wet with water.

In the coupling structure of the present invention, the waterproof means is provided to the opening of the non-through hole, thereby stopping the gap between the non-through hole and the communication cable. This results in enabling the prevention of inflow to the non-through hole from the opening. Accordingly, electric leakage and communication miss can be prevented without making the communication cable through the communication hole get wet with water.

In the coupling structure of the present invention, the ring-shaped waterproof means is provided to the engagement surface of both hinge pieces serving as the opening of the non-through hole without space. The inflow to the non-through hole from the opening is prevented. Accordingly, electric leakage and communication miss can be prevented without making the communication cable through the communication hole get wet with water.

In the coupling structure of the present invention, the main body or one function unit is coupled to the other function unit and at the same time, the energization becomes possible by the connector. Hence, in the coupling structure, the coupling function, the rotating function, and the energizing function can be simultaneously realized. Also, in the coupling structure, the connector is provided at a position deviated from the middle point of the hinge in the rotational axis direction. Therefore, it is obvious to grasp directions of the function unit which connects to the connector and of the function unit which is connected to the connector. Advantageously, the function units, etc. are prevented from being connected in an erroneous direction.

In the coupling structure of the present invention, the hinge pieces constituting the hinge have the same shape. Thus, the hinge piece may be designed and produced to have a single shape, and costs are reduced. So long as a pair of hinge pieces is provided, the fitting necessarily becomes possible and no error occurs upon jointing.

What is claimed is:

1. A coupling structure of an arm portable information apparatus comprising:
a hinge for coupling a plurality of units constituting the arm portable information apparatus; and
a communication hole for communicating a side end surface of one unit anda side end surface of the other unit through a rotational axis of the hinge is formed.

2. A coupling structure of an arm portable information apparatus comprising:
a hinge for coupling a plurality of units constituting the arm portable information apparatus,
wherein a part of an axial core of the hinge is omitted, and
a communication hole for communicating a side end surface of one unit and a side end surface of the other unit through the omitted part of the rotational axis is formed.

3. A coupling structure of an arm portable information apparatus according to claim 2, further comprising:
an axial core is provided to both ends of the rotational axis,
wherein the axial core at the center is omitted.

4. A coupling structure of an arm portable information apparatus according to claim 3,
wherein a drawing-out structure are provided to an end portion of the axial core.

5. A coupling structure of an arm portable information apparatus comprising:
a hinge for coupling a plurality of units constituting the arm portable information apparatus,
a non-through hole is provided in a rotational axis direction from an engagement surface formed by jointing right and left hinge-pieces, and
a through-hole which communicates from the non-through hole to an external side end surface is provided,
a communication hole which communicates a side end surface of one unit and a side end surface of the other unit is formed.

6. A coupling structure of an arm portable information apparatus according to claim 1, further comprising:
a communication cable is communicated through the communication hole.

7. A coupling structure of an arm portable information apparatus according to claim 2, further comprising:
a communication cable is communicated through the communication hole.

8. A coupling structure of an arm portable information apparatus according to claim 5, further comprising:
a communication cable is communicated through the communication hole.

9. A coupling structure of an arm portable information apparatus according to claim 1, wherein
waterproof means is provided to a coupling portion of the hinge.

10. A coupling structure of an arm portable information apparatus according to claim 2, wherein
waterproof means is provided to a coupling portion of the hinge.

11. A coupling structure of an arm portable information apparatus according to claim 5, wherein
waterproof means is provided to a coupling portion of the hinge.

12. A coupling structure of an arm portable information apparatus according to claim 5, further comprising:
ring-shaped waterproof means is provided to an opening of the non-through hole,
an interference is provided to an outer diameter of the waterproof means and an inner diameter of the non-through hole, and
an interference is provided to an inner diameter of the waterproof means and an outer shape of the communication cable to prevent inflow into the non-through hole.

13. A coupling structure of an arm portable information apparatus according to claim 5, further comprising,
ring-shaped waterproof means is provided to an opening of the non-through hole and
an interference is provided in the rotational axis direction to prevent inflow into the non-through hole.

14. A coupling structure of an arm portable information apparatus according to claim 1, furthre comprising:
a connector for connecting the unit to an exit of the communication hole is provided.

15. A coupling structure of an arm portable information apparatus according to claim 2, furthre comprising:
a connector for connecting the unit to an exit of the communication hole is provided.

16. A coupling structure of an arm portable information apparatus according to claim 5, furthre comprising:
a connector for connecting the unit to an exit of the communication hole is provided.

17. A coupling structure of an arm portable information apparatus according to claim 1, further comprising:
hinge pieces constituting the hinge have the same shape.

18. A coupling structure of an arm portable information apparatus according to claim 2, further comprising:
hinge pieces constituting the hinge have the same shape.

19. A coupling structure of an arm portable information apparatus according to claim 5, further comprising:
hinge pieces constituting the hinge have the same shape.
